(19) United States
(12) Patent Application Publication
(10) Pub. No.: US 2013/0274368 A1
(43) Pub. Date: Oct. 17, 2013

(54) Continuous Process For Esterifying Polymers Bearing Acid Groups

(71) Applicants: Matthias Krull, Harxheim (DE); Roman Morschhaeuser, Mainz (DE)

(72) Inventors: Matthias Krull, Harxheim (DE); Roman Morschhaeuser, Mainz (DE)

(73) Assignee: CLARIANT FINANCE (BVI) LIMITED, Tortola (VG)

(21) Appl. No.: 13/977,346

(22) PCT Filed: Dec. 8, 2011
(86) PCT No.: PCT/EP2011/006175

§ 371 Date: Jun. 28, 2013

(30) Foreign Application Priority Data
Dec. 30, 2010 (DE) 10 2010 056 566.0

(51) Int. Cl. C08J 3/28

(52) U.S. Cl. CPC C08J 3/28
USPC 522/129

(57) ABSTRACT

The invention accordingly provides a continuous process for reacting synthetic poly(carboxylic acid)s (A) containing, per polymer chain, at least 10 structural repeat units of formula (I)

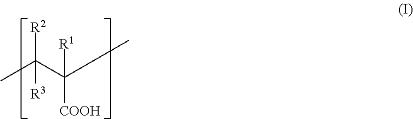

where R¹ is hydrogen, a C₁- to C₄-alkyl group or a group of formula —COOH, R² is hydrogen or a C₁- to C₄-alkyl group, and R³ is hydrogen, a C₁- to C₄-alkyl group or —COOH, with alcohols (B) of general formula (II)

R⁴—(OH)ₙ (II)

where R⁴ is a hydrocarbyl radical of 1 to 100 carbon atoms which may be substituted or which may contain hetero atoms, and n is a number from 1 to 10 by a reaction mixture containing at least one synthetic poly(carboxylic acid) (A) and at least one alcohol of formula (II) in a solvent mixture containing water and, based on the weight of the solvent mixture, 0.1-75% by weight of at least one water-miscible organic solvent, and wherein the organic solvent has a dielectric constant of at least 10 when measured at 25° C., being introduced into a reaction sector and on flowing through the reaction sector being exposed to microwave radiation, and wherein the reaction mixture in the reaction sector is heated by the microwave irradiation to temperatures above 100° C.

The present invention relates to a continuous process for modifying polymers bearing acid groups by polymer-analogous esterification of aqueous solutions of the polymers in a microwave field.

Hydrophobically modified water-soluble synthetic polymers have gained increasing industrial significance in the last few years. These are usually polymers formed mainly from monomers bearing hydrophilic groups and a smaller proportion of monomers bearing hydrophobic groups. These water-soluble polymers aggregate in aqueous solutions owing to intra- and/or intermolecular interactions of the hydrophobic groups with micelle-like structures. As a result, the hydrophobically modified polymers, compared to standard water-soluble polymers, cause an increase in viscosity through the formation of three-dimensional networks at low concentrations, without requiring extremely high molar masses. Such “associative thickeners” efficiently control the rheological properties of water-based liquids in many industrial applications or formulations, for example in paints and coatings, paper, drilling fluids and in oil production. In pharmaceutical and cosmetic applications too, these polymers find use, for example, as stabilizers of colloidal dispersions, of emulsions, liposomes or (nano)particles. In addition, they are used as dispersants for pigments and dyes, the modified polymer acting here as a dispersant for hydrophobic particles through anchoring of the hydrophobic polymer segments on the solid surface and through expansion of the charged hydrophilic groups into the volume phase.

A special case of the hydrophobically modified water-soluble polymers is that of what are called LCST (Lower Critical Solution Temperature) polymers, the side chains of which lose water solubility with rising temperature and thus lead to aggregation or precipitation of the polymer when the temperature increases. Such polymers are of great interest, for example, in mineral oil production as drilling mud additives.

The rheological properties of hydrophobically modified water-soluble synthetic polymers can be adjusted within wide limits, for example through selection of the hydrophobic group and/or the level of modification, and hence adapted to a wide variety of applications.

An important group of hydrophobically associating water-soluble macromolecules is that of hydrophobically modified synthetic poly(carboxylic acids). These can be prepared, for example, by copolymerization of ethylenically unsaturated carboxylic acids with appropriate monomers bearing hydrophobic groups. Hydrophobic comonomers have been found to be especially esters of ethylenically unsaturated carboxylic acids, since they have copolymerization parameters comparable to the hydrophilic monomers. However, the industrial availability thereof is limited, both in terms of the variation of the substituents and in terms of volume, and the synthesis thereof is complex and costly. It is typically effected via the reaction of reactive derivatives of the ethylenically unsaturated carboxylic acids, such as anhydrides, acid chlorides or esters with lower alcohols, with alcohols, forming equimolar amounts of by-products which have to be removed and disposed of. The direct esterification of alcohols with ethylenically unsaturated carboxylic acids, and also the subsequent purification thereof, entails complex measures for prevention of an unwanted uncontrolled polymerization. Furthermore, the preparation of random copolymers often presents difficulties owing to different solubilities of hydrophilic and hydrophobic monomers.

Alternatively, such polymers are also obtainable by polymer-analogous reactions on synthetic, higher molecular weight poly(carboxylic acids), which are available industrially in large volumes. However, direct condensation of poly(carboxylic acids) with alcohols under azeotropic separation of the water of reaction usually fails because of the low solubility of poly(carboxylic acids) in organic solvents. It is typically successful only on copolymers bearing carboxylic acid groups, these having adequate solubility in apolar organic solvents. According to the prior art, such polymer-analogous reactions between poly(carboxylic acids) and alcohols can be performed with coupling reagents, for example N,N′-dicyclohexylcarbodiimide (DCC). Problems which arise are again by-products which form as a result of the process and the different solubilities of the reactants, which often leads to inhomogeneous products.

A more recent approach to the synthesis of carboxylic esters is the direct reaction of carboxylic acids and alcohols to give esters under the influence of microwave radiation. In contrast to conventional processes, no activation of the carboxylic acid using, for example, acid chlorides, acid anhydrides, esters or coupling reagents is required, which means that these processes are of great economic and environmental interest.

J. Org. Chem. 56 (1991), 1313-1314 discloses a distinct acceleration of the reaction rate in the esterification of propanol with acetic acid under the influence of microwave radiation. The reactants are liquids fully miscible with one another.

EP 0 437 480 discloses an apparatus for continuous performance of various chemical reactions. Esterifications are performed using an excess reactant as a solvent.

Macromolecular Chemistry and Physics 2008, 209, 1942-1947 discloses the polymer-analogous esterification of a poly(ether sulfone) bearing acid groups with 1-naphthol in apolar solvents under microwave irradiation.

Macromol. Rapid Commun. 2007, 28, 443-448 discloses the esterification of poly(ethylene-co-acrylic acid) containing 20% by weight of acrylic acid with various phenols in a microwave field. Excess phenol is used as the solvent, this being removed via a precipitation of the polymer.

JP 2009/263497 A discloses the esterification of copolymers of fumaric acid and styrene with octanol under microwave irradiation.

However, these processes cannot be applied directly to the esterification of higher molecular weight synthetic poly(carboxylic acids). Higher molecular weight synthetic poly(carboxylic acids) are high-viscosity substances which are typically solid at room temperature, and which dissolve neither in apolar solvents, for example aliphatic and/or aromatic solvents, nor in most of the alcohols of interest for an esterification. Thus, it is impossible to provide homogeneous mixtures of poly(carboxylic acids) with alcohols, as would be required particularly for a partial modification of the polymer chains with random distribution of the ester groups.

Higher molecular weight synthetic poly(carboxylic acids), in contrast, are of very good water solubility or at least swellability, but water is usually not regarded as a suitable solvent for the performance of condensation reactions. Moreover, relatively highly concentrated aqueous solutions of higher molecular weight synthetic poly(carboxylic acids) required for conversions on the industrial scale have a very high viscosity, which can rise further during a polymer-analogous conversion as a result of formation of hydrophobic domains. This complicates firstly the preparation of homogeneous reaction mixtures with alcohols and secondary the handling thereof, for example in the case of stirring or in the case of pumping in continuous processes. Often, even high-power pumps are inadequate for the conveying of concentrated solutions, and it is necessary to work with conveying units, for example spirals or archimedean screws. In the case of microwave-promoted reactions for continuous performance, as well as mechanical strength, specific demands are made on the material of such units, for example microwave transparency, and ensuring these entails a high level of cost and inconvenience. Moreover, such mechanical apparatuses limit the geometry of the irradiation zone.

The problem addressed was consequently that of providing a continuous process for polymer-analogous modification of synthetic poly(carboxylic acids), in which the properties of synthetic poly(carboxylic acids) can be modified in a simple and inexpensive manner in volumes of industrial interest. More particularly, there is to be no occurrence in the reaction mixture of high viscosities which entail the use of specific conveying units. It shall be possible to influence the solubility and aggregation characteristics of the polymers prepared within wide limits. To achieve constant product properties both within a reaction batch and between different reaction batches, the modification is to be very substantially homogeneous, meaning a random distribution over the entire polymer. Furthermore, no significant amounts of by-products of toxicological and/or environmental concern are to arise.

It has been found that, surprisingly, synthetic poly(carboxylic acids) can be esterified in solutions of water and particular water-miscible solvents with alcohols under the influence of microwaves at temperatures above 100° C. in a continuous process. In the course of the process, the viscosity rises only slightly, if at all. In this way, poly(carboxylic acids) can be modified, for example, to render them hydrophobic or thermally associative. The solubility of polymers modified in such a way gives no pointers to the presence of any large hydrophilic or hydrophobic polymer blocks. Since a multitude of different alcohols is available inexpensively and in industrial volumes, it is thus possible to modify the properties of synthetic poly(carboxylic acids) within wide limits. In these processes—aside from water of reaction—no by-products which have to be removed and disposed of are obtained.

The invention accordingly provides a continuous process for reacting synthetic poly(carboxylic acids) (A) containing, per polymer chain, at least 10 repeat structural units of the formula (I)

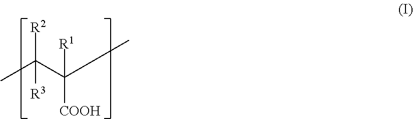

in which
R¹ is hydrogen, a C₁- to C₄-alkyl group or a group of the formula —CH₂—COOH
R² is hydrogen or a C₁- to C₄-alkyl group
R³ is hydrogen, a C₁- to C₄-alkyl group or —COOH,
   with alcohols (B) of the formula (II)

R⁴—(OH)ₙ (II)

in which
R⁴ is a hydrocarbyl radical which has 1 to 100 carbon atoms and may be substituted or contain heteroatoms and
n is a number from 1 to 10,
   in which a reaction mixture comprising at least one synthetic poly(carboxylic acid) (A) and at least one alcohol of the formula (II) in a solvent mixture comprising water and, based on the weight of the solvent mixture, 0.1-75% by weight of at least one water-miscible organic solvent, where the organic solvent has a dielectric constant measured at 25° C. of at least 10, is introduced into a reaction zone, and exposed to microwave radiation as it flows through the reaction zone, the reaction mixture in the reaction zone being heated to temperatures above 100° C. by the microwave irradiation.

The invention further provides polymer-analogously modified synthetic poly(carboxylic acids) prepared by the process according to the invention.

Preferably, R¹ is hydrogen or a methyl group. Additionally preferably, R² is hydrogen. Additionally preferably, R³ is hydrogen or —COOH. In a specific embodiment, R¹, R² and R³ are each hydrogen. In a further specific embodiment, R¹ is a methyl group and R² and R³ are each hydrogen. In a further specific embodiment, R¹ and R² are each hydrogen and R³ is a carboxyl group of the formula —COOH.

Synthetic poly(carboxylic acids) (A) are understood to mean polymers preparable by addition polymerization of ethylenically unsaturated carboxylic acids. Preferred synthetic poly(carboxylic acids) contain structural units derived from acrylic acid, methacrylic acid, crotonic acid, maleic acid, itaconic acid or mixtures thereof. The term “derived structural units” means that the polymer contains structural units which form in the addition polymerization of the acids mentioned. Particular preference is given to homopolymers of said ethylenically unsaturated carboxylic acids, for example poly(acrylic acid), and poly(methacrylic acid). Additionally preferred are copolymers of two or more, for example three or more, ethylenically unsaturated carboxylic acids and especially of the abovementioned ethylenically unsaturated carboxylic acids, for example of acrylic acid and maleic acid or of acrylic acid and itaconic acid.

The process according to the invention is also suitable for modification of poly(carboxylic acids) which, as well as the structural units derived from the abovementioned ethylenically unsaturated carboxylic acids, contain minor amounts of up to 50 mol % of structural units derived from further ethylenically unsaturated monomers. Preferably, the proportion of the structural units derived from further ethylenically unsaturated monomers is between 0.1 and 40 mol %, more preferably between 0.5 and 25 mol % and especially between 1 and 10 mol %, for example between 2 and 5 mol %. Preferred further ethylenically unsaturated monomers are, for example, monomers bearing further acid groups and especially monoethylenically unsaturated compounds having carboxyl groups, for example vinylacetic acid or allylacetic acid, having sulfate or sulfo groups, for example vinylsulfonic acid, allylsulfonic acid, methallylsulfonic acid, 3-sulfopropyl acrylate, 3-sulfopropyl methacrylate, 2-acrylamido-2-methylpropanesulfonic acid (AMPS) or 2-methacrylamido-2-methylpropanesulfonic acid, and also monoethylenically unsaturated compounds having phosphate or phosphonic acid groups, for example vinylphosphoric acid, vinylphosphonic acid, allylphosphonic acid, methacrylamidomethanephosphonic acid, 2-acrylamido-2-methylpropanephosphonic acid, 3-phosphonopropyl acrylate or 3-phosphonopropyl methacrylate. Also suitable as further comonomers are vinyl esters of C₁-C₂₀-carboxylic acids and especially C₂-C₅-carboxylic acids, for example vinyl acetate and vinyl propionate, esters of acrylic acid and methacrylic acid with C₁-C₂₀-alcohols and especially C₂-C₆-alcohols, for example methyl (meth)acrylate, ethyl (meth)acrylate, propyl (meth)acrylate, butyl (meth)acrylate and 2-ethylhexyl (meth)acrylate, and also acrylamide and methacrylamide and the derivatives thereof substituted on the nitrogen by C₁-C₂₀-alkyl radicals, vinyl ethers, for example methyl vinyl ether, N-vinyl compounds, for example N-vinylcaprolactam and N-vinylpyrrolidone, and also olefins, for example ethylene, styrene and butadiene. Preferred copolymers are homogeneously soluble or at least swellable in the solvent mixture of water and the water-miscible organic solvent at temperatures above 40° C., for example at 50° C., 60° C., 70° C., 80° C. or 90° C. Further preferably, they are homogeneously soluble or swellable in the solvent mixture at a concentration of at least 1% by weight and especially 5 to 90% by weight, for example 20 to 80% by weight, at temperatures above 40° C., for example at 50° C., 60° C., 70° C., 80° C. or 90° C. Examples of preferred copolymers are copolymers of
acrylic acid or methacrylic acid and 2-acrylamido-2-methylpropanesulfonic acid (AMPS®) sodium salt,
acrylic acid and 2-ethylhexyl acrylate,
acrylic acid and acrylamide,
acrylic acid and dimethylacrylamide,
methacrylic acid or acrylic acid with tert-butyl methacrylate,
maleic acid and styrene, and
maleic acid and vinyl acetate.

In copolymers of various ethylenically unsaturated carboxylic acids, and also in copolymers of ethylenically unsaturated carboxylic acids with further comonomers, the structural units of the formula (I) derived from ethylenically unsaturated carboxylic acids may be distributed in blocks, in alternation or randomly.

Poly(carboxylic acids) (A) preferred in accordance with the invention have number-average molecular weights above 700 g/mol, more preferably between 1000 and 500 000 g/mol and especially between 2000 and 300 000 g/mol, for example between 2500 and 100000 g/mol, in each case determined by means of gel permeation chromatography against poly(styrenesulfonic acid) standards. Additionally preferably, the poly(carboxylic acids) (A) have an average of at least 10 and especially at least 20, for example 50 to 8000, carboxyl groups per polymer chain. They contain, per polymer chain, preferably at least 20 and especially at least 50 structural units of the formula (I).

In a first preferred embodiment, R⁴ is an aliphatic radical. This preferably has 2 to 50, more preferably 3 to 24 and especially 4 to 20 carbon atoms. The aliphatic radical may be linear, branched or cyclic. It may additionally be saturated or unsaturated, preferably saturated. The hydrocarbyl radical may bear substituents, for example halogen atoms, halogenated alkyl radicals, C₁-C₅-alkoxyalkyl, cyano, nitrile, nitro and/or C₅-C₂₀-aryl groups, for example phenyl radicals. The C₅-C₂₀-aryl radicals may in turn optionally be substituted by halogen atoms, halogenated alkyl radicals, hydroxyl, C₁-C₂₀-alkyl, C₂-C₂₀-alkenyl, C₁-C₅-alkoxy, for example methoxy, ester, amide, cyano, nitrile and/or nitro groups. Particularly preferred aliphatic radicals are methyl, ethyl, n-propyl, isopropyl, n-butyl, isobutyl and tert-butyl, n-hexyl, cyclohexyl, n-heptyl, n-octyl, 2-ethylhexyl, n-decyl, n-dodecyl, tridecyl, isotridecyl, tetradecyl, hexadecyl, octadecyl, eicosyl and methylphenyl.

In a further preferred embodiment, R⁴ is an optionally substituted C₆-C₁₂-aryl group or an optionally substituted heteroaromatic group having 5 to 12 ring members. Preferred heteroatoms are oxygen, nitrogen and sulfur. Further rings may be fused to the C₆-C₁₂-aryl group or the heteroaromatic group having 5 to 12 ring members. The aryl or heteroaromatic group may thus be mono- or polycyclic. Examples of suitable substituents are halogen atoms, halogenated alkyl radicals, and alkyl, alkenyl, hydroxyalkyl, alkoxy, ester, amide, nitrile and nitro groups.

In the alcohol (B), the R⁴ radical bears one or more, for example two, three, four or more, further hydroxyl groups, but not more hydroxyl groups than the R⁴ radical has carbon atoms or than the aryl group has valences. The hydroxyl groups may also be bonded to adjacent carbon atoms or else to further-removed carbon atoms of the hydrocarbyl radical, but no more than one OH group per carbon atom.

In a specific embodiment, n is a number between 2 and 6.

For instance, the process according to the invention is also suitable for esterification of poly(carboxylic acids) (A) with polyols, for example ethylene glycol, 1,2-propanediol, 1,3-propanediol, neopentyl glycol, glycerol, sorbitol, pentaerythritol, fructose and glucose. Crosslinking reactions can occur in the esterification of polyols, which lead to a distinct rise in molecular weight. In the case of such polycondensations, the viscosity of the reaction mixture, which rises during the microwave irradiation, has to be noted in the design of the apparatus. In a particularly preferred embodiment, the alcohol has one hydroxyl group, meaning that n is 1.

In a further preferred embodiment, R⁴ is an alkyl radical interrupted by heteroatoms. Particularly preferred heteroatoms are oxygen and nitrogen. If the R⁴ radical contains nitrogen atoms, these nitrogen atoms, however, do not bear any acidic protons.

For instance, R⁴ preferably represents radicals of the formula (III)

—(R⁵—O)ₘ—R⁶ (III)

in which
R⁵ is an alkylene group having 2 to 18 carbon atoms, preferably having 2 to 12 and especially 2 to 4 carbon atoms, for example ethylene, propylene, butylene or mixtures thereof,
R⁶ is hydrogen, a hydrocarbyl radical having 1 to 24 carbon atoms, an acyl radical of the formula —C(═O)—R⁹ in which R⁹ is a hydrocarbyl radical having 1 to 50 carbon atoms, or a group of the formula —R⁵—NR⁷R⁸,
m is a number between 1 and 500, preferably between 2 and 200 and especially between 3 and 50, for example between 4 and 20, and
R⁷, R⁸ are each independently an aliphatic radical having 1 to 24 carbon atoms and preferably 2 to 18 carbon atoms, an aryl group or heteroaryl group having 5 to 12 ring members, a poly(oxyalkylene) group having 1 to 50 poly(oxyalkylene) units, where the polyoxyalkylene units derive from alkylene oxide units having 2 to 6 carbon atoms, or R⁷ and R⁸ together with the nitrogen atom to which they are bonded form a ring having 4, 5, 6 or more ring members.

Polyethers of the formula (III) suitable in accordance with the invention are obtainable, for example, by alkoxylation of alcohols of the formula R⁴—OH or fatty acids of the formula R⁹—COOH with 2 to 100 mol of ethylene oxide, propylene oxide or a mixture thereof. Preferred polyethers have molecular weights between 300 and 7000 g/mol and more preferably between 500 and 5000 g/mol, for example between 800 and 2500 g/mol. If R⁴ is a radical of the formula (III), n is 1.

Examples of suitable alcohols (B) are methanol, ethanol, n-propanol, isopropanol, n-butanol, isobutanol, tert-butanol, pentanol, neopentanol, n-hexanol, isohexanol, cyclohexanol, heptanol, octanol, 2-ethylhexanol, decanol, dodecanol, tetradecanol, hexadecanol, octadecanol, eicosanol, ethylene glycol, 2-methoxyethanol, propylene glycol, diethylene glycol, triethylene glycol, triethylene glycol monomethyl ether, polyethylene glycol, polyethylene glycol monomethyl ether, polypropylene glycol, triethanolamine, N,N-dimethylethanolamine, N,N-diethylethanolamine, phenol, naphthol and mixtures thereof. Additionally suitable are fatty alcohol mixtures obtained from natural raw materials, for example coconut fatty alcohol, palm kernel fatty alcohol and tallow fatty alcohol, and the reaction products thereof with alkylene oxides.

In the process according to the invention, poly(carboxylic acid) (A) and alcohol (B) can generally be reacted with one another in any desired ratios. Preferably, the reaction is effected with molar ratios between carboxyl groups of the poly(carboxylic acid) (A) and hydroxyl groups of the alcohol (B) of 100:1 to 1:5, preferably of 10:1 to 1:1 and especially of 5:1 to 2:1, based in each case on the equivalents of carboxyl and hydroxyl groups. If the alcohol is used in excess or is reacted incompletely, proportions thereof remain unconverted in the polymer, and these can remain in the product or be removed depending on the end use. This process is particularly advantageous when the alcohol used is volatile or water-soluble. “Volatile” means here that the alcohol has a boiling point at standard pressure of preferably below 250° C., for example below 150° C., and can thus be removed from the ester, optionally together with solvent. This can be effected, for example, by means of distillation, phase separation or extraction. Through the ratio of hydroxyl to carboxyl groups of the polymer, it is possible to adjust the degree of modification and hence the properties of the product.

The process according to the invention is suitable with particular preference for the partial esterification of poly(carboxylic acids) (A). This involves using the alcohol (B) in substoichiometric amounts, based on the total number of carboxyl groups, particularly in a ratio of 1:100 to 1:2 and especially in a ratio of 1:50 to 1:5, for example in a ratio of 1:20 to 1:8. Preference is given to adjusting the reaction conditions such that at least 10 mol %, particularly 20 to 100 mol % and especially 25 to 80 mol %, for example 30 to 70 mol %, of the alcohol (B) used is converted. These partial esterifications form very homogeneous products, which is shown by a uniform solubility.

The production of the reaction mixture used for the process according to the invention, which comprises poly(carboxylic acid) (A), alcohol (B), water, a water-miscible solvent and optionally further assistants, for example emulsifier, catalyst and/or electrolyte, can be effected in various ways. The mixing of poly(carboxylic acid) (A) and alcohol (B) can be performed continuously, batchwise or else in semibatchwise processes. Especially for processes on the industrial scale, it has been found to be useful to feed the reactants to the process according to the invention in liquid form. For this purpose, the poly(carboxylic acid) (A) is fed to the process according to the invention preferably as a solution in water or as a solution in water and a water-miscible solvent. The poly(carboxylic acid) (A) can also be used in swollen form, if this is pumpable.

The alcohol (B) can be used as such if it is liquid or meltable at low temperatures of preferably below 150° C. and especially below 100° C. In many cases, it has been found to be useful to use the alcohol (B), optionally in the molten state, in admixture with water and/or the water-miscible solvent, for example as a solution, dispersion or emulsion.

The mixing of poly(carboxylic acid) (A) with alcohol (B) can be performed in a (semi)batchwise process, by sequential charging of the constituents, for example in a separate stirred vessel. In a preferred embodiment, the alcohol (B) is dissolved in the water-miscible organic solvent and then added to the already dissolved or swollen polymer. Preference is given to addition in small portions over a prolonged period and while stirring, in order firstly to ensure a homogeneous distribution of the alcohol and secondly to avoid local precipitation of the polymer at the metering site.

Particular preference is given to mixing poly(carboxylic acid) (A) with alcohol (B) or solutions or dispersions thereof as described above and optionally further assistants in a mixing zone, from which the reaction mixture, optionally after intermediate cooling, is conveyed into the reaction zone.

If used, a catalyst and further assistants can be added to one of the reactants or else to the reactant mixture prior to entry into the reaction zone. It is also possible to convert heterogeneous systems by the process according to the invention, in which case merely appropriate industrial apparatus for conveying the reaction mixture is required.

The reaction mixture contains preferably 10 to 99% by weight, more preferably 20 to 95% by weight, especially 25 to 90% by weight, for example 50 to 80% by weight, of a solvent mixture of water and one or more water-miscible organic solvents. In each case, water is added to the reactants A and B prior to irradiation with microwaves, such that the reaction product contains an amount of water exceeding the amount of water of reaction released in the esterification.

Preferred water-miscible organic solvents are polar protic, and also polar aprotic liquids. These preferably have a dielectric constant, measured at 25° C., of at least 12 and especially at least 15. Preferred solvents are soluble in water to an extent of at least 100 g/l, more preferably to an extent of at least 200 g/l and particularly to an extent of at least 500 g/l, and are especially completely water-miscible. Particularly preferred solvents are heteroaliphatic compounds and especially alcohols, ketones, end-capped polyethers, carboxamides, for example tertiary carboxamides, nitriles, sulfoxides and sulfones. Preferred aprotic solvents are, for example, formamide, N,N-dimethylformamide (DMF), N,N-dimethylacetamide, acetone, γ-butyrolactone, acetonitrile, sulfolane and dimethyl sulfoxide (DMSO). Preferred protic organic solvents are lower alcohols having 1 to 10 carbon atoms and especially having 2 to 5 carbon atoms. Examples of suitable alcohols are methanol, ethanol, n-propanol, isopropanol, n-butanol, isobutanol, tert-butanol, n-pentanol, 2-pentanol, 3-pentanol, 2-methyl-1-butanol, isoamyl alcohol, 2-methyl-2-butanol, ethylene glycol and glycerol. Particularly preferred lower alcohols are secondary and tertiary alcohols. Particular preference is given to secondary and tertiary alcohols having 3 to 5 carbon atoms, for example isopropanol, sec-butanol, 2-pentanol and 2-methyl-2-butanol, and also neopentyl alcohol. Mixtures of the solvents mentioned are also suitable in accordance with the invention.

In general, low-boiling liquids are preferred as water-miscible organic solvents, particularly those which have a boiling point at standard pressure below 150° C. and especially below 120° C., for example below 100° C., and can thus be removed again from the reaction products with a low level of complexity. High-boiling solvents have been found to be useful, especially when they can remain in the product for the further use of the modified polymers. The proportion of the water-miscible organic solvents in the solvent mixture is preferably between 1 and 60% by weight, more preferably between 2 and 50% by weight, especially between 5 and 40% by weight, for example between 10 and 30% by weight, based in each case on the weight of the solvent mixture. Water is present in the solvent mixture ad 100% by weight.

In a specific embodiment, the alcohol (B) can simultaneously also function as a water-miscible organic solvent. In this embodiment, preferably lower primary alcohols have been found to be useful. Lower primary alcohols preferred here have 1 to 10 carbon atoms and especially 2 to 5 carbon atoms. In this embodiment, the proportion of the lower alcohols in the solvent mixture is preferably between 1 and 60% by weight, more preferably between 2 and 50% by weight, especially between 5 and 40% by weight, for example between 10 and 30% by weight, based in each case on the weight of the solvent mixture. Water is present in the solvent mixture ad 100% by weight.

To further lower the viscosity of the reaction mixture used and/or of the solution of the polymer-analogously modified polymer formed in the course of the process according to the invention, it has been found to be useful in many cases to add electrolytes to the reaction mixture. Preference is given here to strong electrolytes present completely in dissociated form irrespective of concentration. Preferred strong electrolytes are salts of alkali metals and alkaline earth metals, for example the chlorides, phosphates, sulfates, carbonates and hydrogencarbonates thereof. Examples of preferred strong electrolytes are NaCl, KCl, Na₂CO₃, Na₂SO₄ and MgSO₄. The addition of electrolytes simultaneously increases the dielectric loss of the reaction medium, such that more energy can be injected into the reaction mixture per unit time or volume. For the continuous process according to the invention, this means an increase in the amount convertible per unit time, since more reaction mixture can be heated to the desired temperature in the reaction zone with increasing flow rate (and simultaneously increasing microwave energy injected).

In the case of use of alcohols (B) having limited solubility in water or the mixture of water and water-miscible organic solvent, in a preferred embodiment, one or more emulsifiers can be added to the reaction mixture. Preference is given to using emulsifiers which are chemically inert with respect to the reactants and the product. In a particularly preferred embodiment, the emulsifier is reaction product from separate preparation.

In a preferred embodiment, the reactants are fed to the reaction zone from separate vessels in the desired ratio. In a specific embodiment, prior to entry into the reaction zone and/or in the reaction zone itself, they are homogenized further by means of suitable mixing elements, for example a static mixer and/or archimedean screw and/or by flowing through a porous foam.

According to the invention, the reaction of poly(carboxylic acid) (A) with alcohol (B) is effected under the influence of microwave radiation in a reaction zone. The reaction zone comprises at least one vessel in which the reaction mixture is exposed to microwave radiation (irradiation zone), and optionally an isothermal reaction zone which follows downstream thereof in flow direction, and in which the conversion can be completed. In the simplest case, the reaction zone consists of the irradiation zone. In the irradiation zone, the reaction mixture is heated by microwave radiation preferably to temperatures above 110° C., more preferably to temperatures between 120 and 320° C., especially between 130 and 260° C. and especially between 140 and 240° C., for example between 150 and 220° C. These temperatures relate to the maximum temperatures attained during the microwave irradiation. The temperature can be measured, for example, at the surface of the irradiation vessel. It is preferably determined in the reaction mixture directly after it leaves the irradiation zone. The pressure in the reaction zone is preferably set at such a level that the reaction mixture remains in the liquid state and does not boil. Preference is given to working at pressures above 1 bar, preferably at pressures between 3 and 300 bar, more preferably between 5 and 200 and especially between 10 and 100 bar, for example between 15 and 50 bar.

To accelerate or to complete the reaction between poly(carboxylic acid) (A) and alcohol (B), it has been found to be useful in many cases to work in the presence of acidic catalysts. Catalysts preferred in accordance with the invention are acidic inorganic, organometallic or organic catalysts and mixtures of two or more of these catalysts. Preferred catalysts are liquid and/or soluble in the reaction medium.

Acidic inorganic catalysts in the context of the present invention include, for example, sulfuric acid, phosphoric acid, phosphonic acid, hypophosphorous acid, aluminum sulfate hydrate, alum, acidic silica gel and acidic aluminum hydroxide. In addition, for example, aluminum compounds of the general formula Al(OR¹⁵)₃ and titanates of the general formula Ti(OR¹⁵)₄ are usable as acidic inorganic catalysts, where R¹⁵ radicals may each be the same or different and are each independently selected from C₁-C₁₀-alkyl radicals, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, sec-hexyl, n-heptyl, n-octyl, 2-ethylhexyl, n-nonyl or n-decyl, C₃-C₁₂-cycloalkyl radicals, for example cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl. The R¹⁵ radicals in Al(OR¹⁵)₃ or Ti(OR¹⁵)₄ are preferably each the same and are selected from isopropyl, butyl and 2-ethylhexyl.

Preferred acidic organometallic catalysts are, for example, selected from dialkyltin oxides (R¹⁵)₂SnO where R¹⁵ is as defined above. A particularly preferred representative of acidic organometallic catalysts is di-n-butyltin oxide, which is commercially available as “Oxo-tin” or as Fascat® brands.

Preferred acidic organic catalysts are acidic organic compounds with, for example, sulfo groups or phosphonic acid groups. Particularly preferred sulfonic acids contain at least one sulfo group and at least one saturated or unsaturated, linear, branched and/or cyclic hydrocarbon radical having 1 to 40 carbon atoms and preferably having 3 to 24 carbon atoms. Especially preferred are aromatic sulfonic acids, especially alkylaromatic monosulfonic acids having one or more C₁-C₂₈-alkyl radicals and especially those having C₃-C₂₂-alkyl radicals. Suitable examples are methanesulfonic acid, butanesulfonic acid, benzenesulfonic acid, p-toluenesulfonic acid, xylenesulfonic acid, 2-mesitylenesulfonic acid, 4-ethylbenzenesulfonic acid, isopropylbenzenesulfonic acid, 4-butylbenzenesulfonic acid, 4-octylbenzenesulfonic acid; dodecylbenzenesulfonic acid, didodecylbenzenesulfonic acid, naphthalenesulfonic acid.

For the performance of the process according to the invention, particular preference is given to acidic organic catalysts and especially methanesulfonic acid, p-toluenesulfonic acid and dodecylbenzenesulfonic acid.

If the use of acidic inorganic, organometallic or organic catalysts is desired, in accordance with the invention, 0.01 to 10% by weight, preferably 0.02 to 2% by weight, of catalyst is used.

In a further preferred embodiment, the microwave irradiation is performed in the presence of acidic solid catalysts and of catalysts which are insoluble or not fully soluble in the reaction medium. Such heterogeneous catalysts can be suspended in the reaction mixture and exposed to the microwave irradiation together with the reaction mixture. In a particularly preferred continuous embodiment, the reaction mixture, optionally with added solvent, is passed through a fixed bed catalyst fixed in the reaction zone and especially in the irradiation zone, and exposed to microwave radiation in the process. Suitable solid catalysts are, for example, zeolites, silica gel, montmorillonite and (partly) crosslinked polystyrenesulfonic acid, which may optionally be impregnated with catalytically active metal salts. Suitable acidic ion exchangers based on polystyrenesulfonic acids, which can be used as solid phase catalysts, are obtainable, for example, from Rohm & Haas under the Amberlyst® brand name.

After the microwave irradiation, the reaction mixture in many cases can be sent directly to a further use. In order to obtain solvent-free products, water and/or organic solvent can be removed from the crude product by customary separation processes, for example distillation, freeze-drying or absorption. At the same time, it is also possible to additionally remove alcohol used in excess and any unconverted residual amounts of alcohol. For specific requirements, the crude products can be purified further by customary purifying processes, for example washing, reprecipitation, filtration, dialysis or chromatographic processes.

The microwave irradiation is typically performed in instruments which possess an irradiation vessel made from a very substantially microwave-transparent material, into which microwave irradiation generated in a microwave generator is injected. Microwave generators, for example the magnetron, the klystron and the gyrotron, are known to those skilled in the art.

The irradiation vessels used to perform the process according to the invention are preferably manufactured from substantially microwave-transparent, high-melting material or comprise at least parts, for example windows, made of these materials. Particular preference is given to using nonmetallic irradiation vessels. Substantially microwave-transparent materials are understood here to mean those which absorb a minimum amount of microwave energy and convert it to heat. A measure often employed for the ability of a substance to absorb microwave energy and convert it to heat is the dielectric loss factor tan δ=∈″/∈′. The dielectric loss factor tan ∈ is defined as the ratio of dielectric loss ∈″ and dielectric constant ∈′. Examples of tan δ values of different materials are reproduced, for example, in D. Bogdal, Microwave-assisted Organic Synthesis, Elsevier 2005. For irradiation vessels suitable in accordance with the invention, materials with tan 6 values measured at 2.45 GHz and 25° C. of less than 0.01, particularly less than 0.005 and especially less than 0.001 are preferred. Preferred microwave-transparent and thermally stable materials include primarily mineral-based materials, for example quartz, alumina, zirconia, silicon nitride and the like. Also suitable as vessel materials are thermally stable plastics such as, more particularly, fluoropolymers, for example Teflon, and industrial plastics such as polypropylene, or polyaryl ether ketones, for example glass fiber reinforced polyetheretherketone (PEEK). In order to withstand the temperature conditions during the reaction, especially minerals, such as quartz or alumina, coated with these plastics have been found to be useful as vessel materials.

Microwaves refer to electromagnetic rays with a wavelength between about 1 cm and 1 m and frequencies between about 300 MHz and 30 GHz. This frequency range is suitable in principle for the process according to the invention. For the process according to the invention, preference is given to using microwave radiation with frequencies approved for industrial, scientific and medical applications, for example with frequencies of 915 MHz, 2.45 GHz, 5.8 GHz or 24.12 GHz. The microwave irradiation of the reaction mixture can be effected either in microwave applicators which work in monomode or quasi-monomode, or in those which work in multimode. Corresponding instruments are known to those skilled in the art.

The microwave power to be injected into the irradiation vessel for the performance of the process according to the invention is dependent especially on the target reaction temperature, the geometry of the irradiation vessel and the associated reaction volume, and on the flow rate of the reaction mixture through the irradiation vessel. It is typically between 100 W and several hundreds of kW and especially between 200 W and 100 kW, for example between 500 W and 70 kW. It can be applied at one or more points in the irradiation vessel. It can be generated by means of one or more microwave generators.

The duration of the microwave irradiation depends on various factors, such as the reaction volume, the geometry of the irradiation vessel, the desired residence time of the reaction mixture at reaction temperature, and the desired degree of conversion. Typically, the microwave irradiation is undertaken over a period of less than 30 minutes, preferably between 0.01 second and 15 minutes, more preferably between 0.1 second and 10 minutes, and especially between one second and 5 minutes, for example between 5 seconds and 2 minutes. The intensity (power) of the microwave radiation is adjusted such that the reaction mixture attains the target reaction temperature within a minimum time. In a further preferred embodiment of the process according to the invention, it has been found to be useful to supply the reaction mixture to the irradiation vessel in heated form. To maintain the reaction temperature, the reaction mixture can be irradiated further with reduced and/or pulsed power, or kept to temperature by some other means. In a preferred embodiment, the reaction product is cooled directly after the microwave irradiation has ended, very rapidly to temperatures below 100° C., preferably below 80° C. and especially below 50° C.

The microwave irradiation is preferably effected in a flow tube which serves as an irradiation vessel, which is also referred to hereinafter as reaction tube. It can additionally be performed in semibatchwise processes, for example continuous stirred reactors or cascade reactors. In a preferred embodiment, the reaction is performed in a closed, pressure-resistant and chemically inert vessel, in which case the water and in some cases the alcohol (B) and the water-miscible solvent lead to a pressure buildup. After the reaction has ended, the elevated pressure can be used, by decompression, to volatilize and remove water, organic solvent and any excess alcohol (B) and/or to cool the reaction product. In a particularly preferred embodiment, the reaction mixture, after the microwave irradiation has ended or after leaving the irradiation vessel, is freed very rapidly from water and any catalytically active species present, in order to avoid hydrolysis of the ester formed. The water and the organic solvent can be removed by customary separation processes, for example freeze drying, distillation or absorption.

In a particularly preferred embodiment of the process according to the invention, the reaction mixture is conducted continuously through a pressure-resistant reaction tube which is inert with respect to the reactants, is very substantially microwave-transparent, has been installed into a microwave applicator and serves as the irradiation zone. This reaction tube preferably has a diameter of one millimeter to approx. 50 cm, especially between 2 mm and 35 cm, for example between 5 mm and 15 cm. The diameter of the reaction tube is more preferably less than the penetration depth of the microwaves into the reaction mixture to be irradiated. It is particularly 1 to 70% and especially 5 to 60%, for example 10 to 50%, of the penetration depth. Penetration depth is understood to mean the distance over which the incident microwave energy is attenuated to 1/e.

Flow tubes or reaction tubes are understood here to mean irradiation vessels in which the ratio of length to diameter of the irradiation zone (this is understood to mean the portion of the flow tube in which the reaction mixture is exposed to microwave radiation) is greater than 5, preferably between 10 and 100 000, more preferably between 20 and 10 000, for example between 30 and 1000. They may, for example, be straight or curved, or else take the form of a pipe coil. In a specific embodiment, the reaction tube is configured in the form of a jacketed tube through whose interior and exterior the reaction mixture can be conducted successively in countercurrent, in order, for example, to increase the thermal conduction and energy efficiency of the process. The length of the reaction tube is understood to mean the total distance through which the reaction mixture flows in the microwave field. Over its length, the reaction tube is surrounded by at least one microwave radiator, but preferably by more than one, for example two, three, four, five, six, seven, eight or more microwave radiators. The microwaves are preferably injected through the tube jacket. In a further preferred embodiment, the microwaves are injected by means of at least one antenna via the tube ends.

The reaction zone is typically provided at the inlet with a metering pump and a manometer, and at the outlet with a pressure-retaining device and a heat exchanger. Preferably, the reaction mixture is fed to the reaction zone in liquid form with temperatures below 100° C., for example between 10° C. and 90° C. In a further preferred embodiment, a solution of the polymer (A) and alcohol (B) is mixed only shortly prior to entry into the reaction zone, optionally with the aid of suitable mixing elements, for example static mixers and/or archimedean screw and/or by flowing through a porous foam. In a further preferred embodiment, they are homogenized further in the reaction zone by means of suitable mixing elements, for example a static mixer and/or archimedean screw and/or by flowing through a porous foam.

Through variation of tube cross section, length of the irradiation zone, flow rate, geometry of the microwave radiators, the incident microwave power and the temperature attained, the reaction conditions are adjusted such that the maximum reaction temperature is achieved very rapidly. In a preferred embodiment, the residence time chosen at maximum temperature is short, such that as low as possible a level of side reactions and further reactions occurs.

Preferably, the continuous microwave reactor is operated in monomode or quasi-monomode. The residence time of the reaction mixture in the irradiation zone is generally below 20 minutes, preferably between 0.01 second and 10 minutes, preferably between 0.1 second and 5 minutes, for example between one second and 3 minutes. To complete the reaction, the reaction mixture, optionally after intermediate cooling, can flow through the irradiation zone several times.

In a particularly preferred embodiment, the irradiation of the reaction mixture with microwaves is effected in a reaction tube whose longitudinal axis is in the direction of propagation of the microwaves in a monomode microwave applicator. The length of the irradiation zone is preferably at least half the wavelength, more preferably at least the wavelength and up to 20 times, especially 2 to 15 times, for example 3 to 10 times, the wavelength of the microwave radiation used. With this geometry, energy from a plurality of, for example two, three, four, five, six or more, successive maxima of the microwave which propagates parallel to the longitudinal axis of the tube can be transferred to the reaction mixture, which distinctly improves the energy efficiency of the process.

The irradiation of the reaction mixture with microwaves is preferably effected in a substantially microwave-transparent straight reaction tube within a hollow conductor which functions as a microwave applicator and is connected to a microwave generator. The reaction tube is preferably aligned axially with a central axis of symmetry of this hollow conductor. The hollow conductor preferably takes the form of a cavity resonator. The length of the cavity resonator is preferably such that a standing wave forms therein. Additionally preferably, the microwaves not absorbed in the hollow conductor are reflected at the end thereof. Configuration of the microwave applicator as a resonator of the reflection type achieves a local increase in the electrical field strength at the same power supplied by the generator and increased energy exploitation.

The cavity resonator is preferably operated in E₀₁ₙ mode where n is an integer and specifies the number of field maxima of the microwave along the central axis of symmetry of the resonator. In this mode of operation, the electrical field is directed in the direction of the central axis of symmetry of the cavity resonator. It has a maximum in the region of the central axis of symmetry and decreases to the value of zero toward the outer surface. This field configuration is rotationally symmetric about the central axis of symmetry. Use of a cavity resonator with a length where n is an integer enables the formation of a standing wave. According to the desired flow rate of the reaction mixture through the reaction tube, the temperature required and the residence time required in the resonator, the length of the resonator is selected relative to the wavelength of the microwave radiation used. n is preferably an integer from 1 to 200, more preferably from 2 to 100, particularly from 3 to 50, especially from 4 to 20, for example three, four, five, six, seven, eight, nine or ten. The E₀₁ₙ mode of the cavity resonator is also referred to in English as the TM₀₁ₙ (transversal magnetic) mode; see, for example, K. Lange, K. H. Locherer, “Taschenbuch der Hochfrequenztechnik” [Handbook of High-Frequency Technology], volume 2, pages K21 ff.

The microwave energy can be injected into the hollow conductor which functions as the microwave applicator through holes or slots of suitable dimensions. In a specific embodiment of the process according to the invention, the reaction mixture is irradiated with microwaves in a reaction tube present in a hollow conductor with coaxial crossing of the microwaves. Microwave devices particularly preferred for this process are formed from a cavity resonator, a coupling device for injecting a microwave field into the cavity resonator and with one orifice each on two opposite end walls for passage of the reaction tube through the resonator. The microwaves are preferably injected into the cavity resonator by means of a coupling pin which projects into the cavity resonator. The coupling pin is preferably configured as a preferably metallic inner conductor tube which functions as a coupling antenna. In a particularly preferred embodiment, this coupling pin projects through one of the end orifices into the cavity resonator. The reaction tube more preferably adjoins the inner conductor tube of the coaxial crossing, and is especially conducted through the cavity thereof into the cavity resonator. The reaction tube is preferably aligned axially with a central axis of symmetry of the cavity resonator, for which the cavity resonator preferably has a central orifice on each of two opposite end walls to pass the reaction tube through.

The microwaves can be fed into the coupling pin or into the inner conductor tube which functions as a coupling antenna, for example, by means of a coaxial connecting line. In a preferred embodiment, the microwave field is supplied to the resonator via a hollow conductor, in which case the end of the coupling pin projecting out of the cavity resonator is conducted into the hollow conductor through an orifice in the wall of the hollow conductor, and takes microwave energy from the hollow conductor and injects it into the resonator.

In a specific embodiment, the reaction mixture is irradiated with microwaves in a microwave-transparent reaction tube which is axially symmetric within an E₀₁ₙ round hollow conductor with coaxial crossing of the microwaves. The reaction tube is conducted through the cavity of an inner conductor tube which functions as a coupling antenna into the cavity resonator. In a further preferred embodiment, the reaction mixture is irradiated with microwaves in a microwave-transparent reaction tube which is conducted through an E₀₁ₙ cavity resonator with axial introduction of the microwaves, the length of the cavity resonator being such as to form n=2 or more field maxima of the microwave. In a further preferred embodiment, the reaction mixture is irradiated with microwaves in a microwave-transparent reaction tube which is conducted through an E₀₁ₙ cavity resonator with axial introduction of the microwaves, the length of the cavity resonator being such as to form a standing wave where n=2 or more field maxima of the microwave. In a further preferred embodiment, the reaction mixture is irradiated with microwaves in a microwave-transparent reaction tube which is axially symmetric within a circular cylindrical E₀₁ₙ cavity resonator with coaxial crossing of the microwaves, the length of the cavity resonator being such as to form n=2 or more field maxima of the microwave. In a further preferred embodiment, the reaction mixture is irradiated with microwaves in a microwave-transparent reaction tube which is axially symmetric within a circular cylindrical E₀₁ₙ cavity resonator with coaxial crossing of the microwaves, the length of the cavity resonator being such as to form a standing wave where n=2 or more field maxima of the microwave.

E₀₁ cavity resonators particularly suitable for the process according to the invention preferably have a diameter which corresponds to at least half the wavelength of the microwave radiation used. The diameter of the cavity resonator is preferably 1.0 to 10 times, more preferably 1.1 to 5 times and especially 2.1 to 2.6 times half the wavelength of the microwave radiation used. The E₀₁ cavity resonator preferably has a round cross section, which is also referred to as an E₀₁ round hollow conductor. It more preferably has a cylindrical shape and especially a circular cylindrical shape.

On departure from the irradiation zone, the conversion of the reaction mixture is often not yet in chemical equilibrium. In a preferred embodiment, the reaction mixture is therefore, after passing through the irradiation zone, transferred directly, i.e. without intermediate cooling, into an isothermal reaction zone in which it continues to be kept at reaction temperature for a certain time. Only after leaving the isothermal reaction zone is the reaction mixture optionally decompressed and cooled. Direct transfer from the irradiation zone to the isothermal reaction zone is understood to mean that no active measures are taken for supply and more particularly for removal of heat between irradiation zone and isothermal reaction zone. Preferably, the temperature difference between departure from the irradiation zone and entry into the isothermal reaction zone is less than ±30° C., preferably less than ±20° C., more preferably less than ±10° C. and especially less than ±5° C. In a specific embodiment, the temperature of the reaction mixture on entry into the isothermal reaction zone corresponds to the temperature on departure from the irradiation zone. This embodiment enables rapid and controlled heating of the reaction mixture to the desired reaction temperature without partial overheating, and then residence at this reaction temperature for a defined period before it is cooled. In this embodiment, the reaction mixture is preferably, directly after leaving the isothermal reaction zone, cooled very rapidly to temperatures below 120° C., preferably below 100° C. and especially below 60° C.

Useful isothermal reaction zones include all chemically inert vessels which enable residence of the reaction mixtures at the temperature established in the irradiation zone. An isothermal reaction zone is understood to mean that the temperature of the reaction mixture in the isothermal reaction zone relative to the entrance temperature is kept constant within ±30° C., preferably within ±20° C., more preferably within ±10° C. and especially within ±5° C. Thus, the reaction mixture on departure from the isothermal reaction zone has a temperature which deviates from the temperature on entry into the isothermal reaction zone by not more than ±30° C., preferably ±20° C., more preferably ±10° C. and especially ±5° C.

In addition to continuous stirred tanks and tank cascades, especially tubes are suitable as the isothermal reaction zone. These reaction zones may consist of different materials, for example metals, ceramic, glass, quartz or plastics, with the proviso that they are mechanically stable and chemically inert under the selected temperature and pressure conditions. It has been found that thermally insulated vessels are particularly useful. The residence time of the reaction mixture in the isothermal reaction zone can be adjusted, for example, via the volume of the isothermal reaction zone. In the case of use of stirred tanks and tank cascades, it has been found to be equally useful to establish the residence time via the fill level of the tanks. In a preferred embodiment, the isothermal reaction zone is equipped with active or passive mixing elements.

In a preferred embodiment, the isothermal reaction zone used is a tube. This may be an extension of the microwave-transparent reaction tube downstream of the irradiation zone, or else a separate tube of the same or different material connected to the reaction tube. For a given flow rate, the residence time of the reaction mixture can be determined over the length of the tube and/or cross section thereof. The tube which functions as the isothermal reaction zone is thermally insulated in the simplest case, such that the temperature which exists on entry of the reaction mixture into the isothermal reaction zone is held within the limits given above. However, it is also possible, for example by means of a heat carrier or cooling medium, to supply energy in a controlled manner to the reaction mixture in the isothermal reaction zone, or remove it therefrom. This embodiment has been found to be useful especially for startup of the apparatus or of the process. For example, the isothermal reaction zone may be configured as a tube coil or as a tube bundle which is within a heating or cooling bath or is charged with a heating or cooling medium in the form of a jacketed tube. The isothermal reaction zone may also be within a further microwave applicator in which the reaction mixture is treated once again with microwaves. In this case, it is possible to use either monomode or multimode applicators.

The residence time of the reaction mixture in the isothermal reaction zone is preferably such that the thermal equilibrium state defined by the existing conditions is attained. Typically, the residence time is between 1 second and 10 hours, preferably between 10 seconds and 2 hours, more preferably between 20 seconds and 60 minutes, for example between 30 seconds and 30 minutes. Additionally preferably, the ratio between residence time of the reaction mixture in the isothermal reaction zone and residence time in the irradiation zone is between 1:2 and 100:1, more preferably 1:1 to 50:1 and especially between 1:1.5 and 10:1.

To achieve particularly high conversions, it has been found to be useful in many cases to expose the reaction product obtained again to microwave irradiation, in which case it is optionally possible to make up the ratio of the reactants used to compensate for spent or deficient reactants.

The process according to the invention enables the polymer-analogous modification of synthetic poly(carboxylic acids) with alcohols in a continuous process in volumes of industrial interest. Aside from water, this does not give rise to any by-products which have to be disposed of and pollute the environment. A further advantage of the process according to the invention lies in the fact that the polymer-analogous condensation reactions can be undertaken in aqueous solution, since water is the solvent of best suitability for poly(carboxylic acids), and is additionally advantageous from environmental aspects. The addition of particular polar organic solvents can counteract any viscosity rise which occurs as a result of onset of formation of hydrophobically modified structural units, and also facilitates reaction with alcohols of relatively low water solubility. Thus, no specific conveying units are required to maintain the flow, which is necessary in continuous processes, of the reaction mixture through the irradiation zone. In this way, poly(carboxylic acids) can be modified, for example, to render them hydrophobic or thermally associative. More particularly, the process according to the invention is suitable for partial esterifications of higher molecular weight synthetic poly(carboxylic acids), since the reaction mixtures, in spite of viscosity and solubility differences between poly(carboxylic acids) (A) and alcohols (B), lead to a homogeneous distribution of the alcohol (B) over the entire chain length of the polymer (A). The process according to the invention allows the reproducible preparation of products modified randomly along their chain length. The variety of alcohols available in industrial volumes for the process according to the invention opens up a wide range of possible modifications. It is thus possible in a simple manner to modify the properties of synthetic poly(carboxylic acids) within wide limits.

### EXAMPLES

The irradiation of the reaction mixtures with microwaves was effected in an alumina reaction tube (60×1 cm) which was present in axial symmetry in a cylindrical cavity resonator (60×10 cm). At one of the ends of the cavity resonator, the reaction tube ran through the cavity of an inner conductor tube which functions as a coupling antenna. The microwave field with a frequency of 2.45 GHz, generated by a magnetron, was injected into the cavity resonator by means of the coupling antenna (E₀₁ cavity applicator; monomode), in which a standing wave formed. In the case of use of an isothermal reaction zone, the heated reaction mixtures, immediately after leaving the reaction tube, were conveyed through a thermally insulated stainless steel tube (3.0 m×1 cm, unless stated otherwise). After leaving the reaction tube, or after leaving the isothermal reaction zone in the case of use thereof, the reaction mixtures were decompressed to atmospheric pressure, and cooled immediately to the temperature specified by means of an intensive heat exchanger, and the catalyst was neutralized.

The microwave power was adjusted over the experimental duration in each case in such a way that the desired temperature of the reaction mixture at the end of the irradiation zone was kept constant. The microwave powers specified in the experimental descriptions therefore represent the mean value of the incident microwave power over time. The measurement of the temperature of the reaction mixture was undertaken directly after departure from the irradiation zone by means of a Pt100 temperature sensor. Microwave energy not absorbed directly by the reaction mixture was reflected at the opposite end of the cavity resonator from the coupling antenna; the microwave energy which was also not absorbed by the reaction mixture on the return path and reflected back in the direction of the magnetron was passed with the aid of a prism system (circulator) into a water-containing vessel. The difference between energy injected and heating of this water load was used to calculate the microwave energy introduced into the reaction mixture.

By means of a high-pressure pump and of a pressure-release valve, the reaction mixture in the reaction tube was placed under such a working pressure that was sufficient always to keep all reactants and products or condensation products in the liquid state. The reaction mixtures were pumped through the apparatus at a constant flow rate and the residence time in the irradiation zone was adjusted by modifying the flow rate.

The reaction products were analyzed by means of ¹H NMR spectroscopy at 500 MHz in CDCl₃.

### Example 1

### Esterification of Poly(Acrylic Acid) with Methanol

A 10 l Büchi stirred autoclave with gas inlet tube, stirrer, internal thermometer and pressure equalizer was initially charged with a solution of 2.0 kg of poly(acrylic acid) (molecular weight 5000 g/mol) in 4 kg of water, 20 g of p-toluenesulfonic acid were added, and the mixture was heated to 40° C. At this temperature, 1 kg of methanol (1.1 mol of methanol per acid function of the polymer) was added while stirring over a period of 10 minutes.

The reaction mixture thus obtained was pumped continuously through the reaction tube at 6 l/h and a working pressure of 35 bar and exposed to a microwave power of 2.5 kW, 92% of which was absorbed by the reaction mixture. The residence time of the reaction mixture in the irradiation zone was about 40 seconds. On departure from the reaction tube, the reaction mixture had a temperature of 235° C. and was transferred directly at this temperature to the isothermal reaction zone. At the end of the isothermal reaction zone, the reaction mixture had a temperature of 221° C. Directly after leaving the reaction zone, the reaction mixture was cooled to room temperature.

The reaction product was a homogeneous, colorless solution with low viscosity. Evaporating off the solvent resulted in a viscous, hygroscopic material, the IR spectrum of which shows a band characteristic of esters at 1735 cm⁻¹ and signals characteristic of methyl esters in the ¹H NMR spectrum at 3.6 ppm (—CO—O—CH₃). By comparison of the integral of the signal at 3.6 ppm with that of the backbone protons (—CH₂—) and (—CH—CO—) of the polyacrylic acid, an esterification level of 35% was determined. By means of titration of the remaining acid groups with NaOH (taking account of the catalyst), this value was confirmed. As expected, neutralization of the remaining acid functions led to a distinct improvement in the solubility. The polymer, which in the unneutralized state goes only into a cloudy solution in water, dissolves immediately to give a clear solution even after addition of small amounts of alkali, and virtually without any viscosity increase.

### Example 2

### Esterification of Poly(Acrylic Acid) with 2-Ethylhexanol

A 10 l Büchi stirred autoclave with gas inlet tube, stirrer, internal thermometer and pressure equalizer was initially charged with a solution of 2.0 kg of poly(acrylic acid) (27.7 mol, molecular weight 1800 g/mol) in 4 kg of water, and 30 g of sulfuric acid were added. Subsequently, the mixture was heated to 30° C. and, at this temperature, a solution of 1 kg of 2-ethylhexanol (7.7 mol) in 3 kg of isopropanol was added over a period of one hour.

The reaction mixture thus obtained was pumped continuously through the reaction tube at 5 l/h and a working pressure of 35 bar and exposed to a microwave power of 2.5 kW, 90% of which was absorbed by the reaction mixture. The residence time of the reaction mixture in the irradiation zone was about 48 seconds. On departure from the reaction tube, the reaction mixture had a temperature of 257° C. and was transferred directly at this temperature to the isothermal reaction zone. At the end of the isothermal reaction zone, the reaction mixture had a temperature of 225° C. Directly after leaving the reaction zone, the reaction mixture was cooled to room temperature and the catalyst was neutralized with sodium hydroxide solution.

The reaction product was a solution of pale yellowish color with low viscosity. Evaporating off the solvent and reprecipitation from methanol resulted in a viscous material, the IR spectrum of which shows a band characteristic of esters at 1735 cm⁻¹ and signals characteristic of aliphatic —CH₃ groups in the ¹H NMR spectrum at 0.9 ppm. The comparison with the integrals of the backbone protons showed a conversion of 13% of the acid functions. By means of titration of the remaining acid groups with NaOH, an esterification level of 15 mol % was determined.

### Example 3

### Esterification of Poly(Acrylic Acid) with Methyl Tetraethylene Glycol

A 10 l Büchi stirred autoclave with gas inlet tube, stirrer, internal thermometer and pressure equalizer was initially charged with a solution of 2.0 kg of poly(acrylic acid) (molecular weight 5000 g/mol) in 4 kg of water, 20 g of methanesulfonic acid were added, and the mixture was heated to 35° C. At this temperature, a solution of 1 kg of methyl tetraethylene glycol (4.8 mol) in 1 kg of isopropanol was added while stirring over a period of one hour.

The reaction mixture thus obtained was pumped continuously through the reaction tube at 6.2 l/h and a working pressure of 33 bar and exposed to a microwave power of 2.3 kW, 89% of which was absorbed by the reaction mixture. The residence time of the reaction mixture in the irradiation zone was about 38 seconds. On departure from the reaction tube, the reaction mixture had a temperature of 247° C. and was transferred directly at this temperature to the isothermal reaction zone. At the end of the isothermal reaction zone, the reaction mixture had a temperature of 234° C. Directly after leaving the reaction zone, the reaction mixture was cooled to room temperature and the catalyst was neutralized with hydrogencarbonate solution.

The reaction product was a slightly viscous solution of pale yellowish color. Evaporating off the solvent and reprecipitation of the reaction product from methanol/acetone resulted in a viscous, extremely tacky material, the IR spectrum of which shows a band characteristic of esters at 1735 cm⁻¹. By titration of the unconverted acid groups with NaOH, an esterification level of 8 mol % of the carboxyl groups was found.

### Example 4

### Esterification of Poly(Acrylic Acid) with Coconut Fatty Alcohol Ethoxylate (10 EO)

A 10 l Büchi stirred autoclave with gas inlet tube, stirrer, internal thermometer and pressure equalizer was initially charged with a solution of 1.0 kg of poly(acrylic acid) (molecular weight 50 000 g/mol) 4 kg of water, and 15 g of methanesulfonic acid were added. At 40° C., a solution of 670 g of coconut fatty alcohol ethoxylate (Genapol® C 100, about 1 mol) in 2 kg of isopropanol was then added while stirring over a period of a half hour.

The reaction mixture thus obtained was pumped continuously through the reaction tube at 5 l/h and a working pressure of 35 bar and exposed to a microwave power of 2.1 kW, 93% of which was absorbed by the reaction mixture. The residence time of the reaction mixture in the irradiation zone was about 48 seconds. On departure from the reaction tube, the reaction mixture had a temperature of 227° C. and was transferred directly at this temperature to the isothermal reaction zone. At the end of the isothermal reaction zone, the reaction mixture had a temperature of 209° C. The reaction product was subsequently neutralized by means of sodium carbonate and freed of the solvent under reduced pressure. By means of a Soxhlet apparatus, the unconverted fractions of the coconut fatty alcohol ethoxylate were extracted from an aliquot with boiling t-butanol and, after removal of the solvent, determined gravimetrically. By back-calculation for the total mass of the batch, a conversion of 64% of the coconut fatty alcohol ethoxylate used was found.

### Example 5

### Attempted Esterification of Poly(Acrylic Acid) with 2-Ethylhexanol in Water (Comparative)

The method employed was analogous to experiment 2, except without addition of an organic solvent. By vigorous stirring of the initial charge, only a suspension of moderate stability was prepared, and this separated again after the shear had ended. Owing to the rapid phase separation, no perceptible conversion was achieved.

### Example 6

### Attempted esterification of poly(acrylic acid) with methyl tetra(ethylene glycol) in water (comparative)

The method employed was analogous to experiment 3, except without addition of an organic solvent. To establish a comparable active ingredient concentration in the reaction mixture, the amount of the solvent used in experiment 3 was replaced by water and was added to the poly(acrylic acid). In the case of addition of the methyl tetra(ethylene glycol) to the poly(acrylic acid) solution heated to 55° C., the viscosity of the reaction mixture rose perceptibly, but it still remained pumpable.

In the course of pumping of the reaction mixture through the reaction tube exposed to microwave radiation, there was a further distinct rise in viscosity, which led to blockage of the reaction tube and to termination of the experiment.

1. A continuous process for reacting at least one synthetic poly(carboxylic acid) (A) containing, per polymer chain, an average of at least 10 repeat structural units of the formula (I) 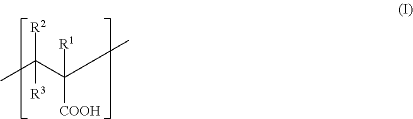
in which
R¹ is hydrogen, a C₁- to C₄-alkyl group or a group of the formula —CH₂—COOH
R² is hydrogen or a C₁- to C₄-alkyl group
R³ is hydrogen, a C₁- to C₄-alkyl group or —COON,
with at least one alcohol (B) of the formula (II)
R⁴—(OH)ₙ (II)
in which
R⁴ is a hydrocarbyl radical which has 1 to 100 carbon atoms and may be substituted or contain heteroatoms and
n is a number from 1 to 10,
and where the compound of the formula (II) contains not more than as many OH groups as the R⁴ radical has carbon atoms, or valences in the case of an aryl group, or
in which the at least one alcohol is a polyether alcohol of the formula (III)
HO—(R⁵—O)ₘ—R⁶ (Ill)
in which
R⁵ is an alkylene group having 2 to 18 carbon atoms,
R⁶ is hydrogen, a hydrocarbyl radical having 1 to 24 carbon atoms, an acyl radical of the formula —C(═O)—R⁹ in which R⁹ is a hydrocarbyl radical having 1 to 50 carbon atoms, or a group of the formula —R⁵—NR⁷R⁸,
m is a number between 1 and 500, and
R⁷, R⁸ are each independently an aliphatic radical having 1 to 24 carbon atoms an aryl group or heteroaryl group having 5 to 12 ring members, a poly(oxyalkylene) group having 1 to 50 poly(oxyalkylene) units, where the polyoxyalkylene units derive from alkylene oxide units having 2 to 6 carbon atoms, or R⁷ and R⁸ together with the nitrogen atom to which they are bonded form a ring having 4, 5, 6 or more ring members,
by introducing a reaction mixture comprising at least one synthetic poly(carboxylic acid) (A) and at least one alcohol of the formula (II) in a solvent mixture comprising water and, based on the weight of the solvent mixture, 0.1-75% by weight of at least one water-miscible organic solvent, where the organic solvent has a dielectric constant measured at 25° C. of at least 10, into a reaction zone, and exposing it to microwave radiation as it flows through the reaction zone, the reaction mixture in the reaction zone being heated to temperatures above 100° C. by the microwave irradiation.

2. The process as claimed in claim 1, in which the at least one poly(carboxylic acid) (A) is a homopolymer of acrylic acid, methacrylic acid, maleic acid or itaconic acid or a copolymer of two or more of these monomers.

3. The process as claimed in claim 1, in which the at least one poly(carboxylic acid) (A) is a copolymer of acrylic acid, methacrylic acid, maleic acid and/or itaconic acid, and at least one further ethylenically unsaturated monomer.

4. The process as claimed in claim 2, in which the copolymers contain the structural units of the formula (I) derived from ethylenically unsaturated carboxylic acids in block, alternating or random sequence.

5. The process as claimed in claim 1, in which the at least one poly(carboxylic acid) has a mean molecular weight of at least 700 g/mol, determined by means of gel permeation chromatography against poly(styrenesulfonic acid) standards.

6. The process as claimed in claim 1, in which R⁴ contains 2 to 50 carbon atoms.

7. The process as claimed in claim 1, in which R⁴ is an aliphatic radical.

8. The process as claimed in claim 1, in which R⁴ is an aromatic radical, and contains at least 6 carbon atoms.

9. The process as claimed in claim 1, in which the reaction mixture used for conversion contains 10 to 99% by weight of a mixture of water and a water-miscible organic solvent.

10. The process as claimed in claim 1, in which a solvent mixture of 1 to 60% by weight of a water-miscible organic solvent with water ad 100% by weight is used.

11. The process as claimed in claim 1, in which the water-miscible solvent is a polar protic organic liquid.

12. The process as claimed in claim 11, in which the water-miscible solvent is an alcohol.

13. The process as claimed in claim 1, in which the water-miscible solvent is a polar aprotic organic liquid.

14. The process as claimed in claim 13, in which the water-miscible solvent is selected from the group consisting of formamide, N,N-dimethylformamide (DMF), N,N-dimethylacetamide, acetone, γ-butyrolactone, acetonitrile, sulfolane and dimethyl sulfoxide (DMSO).

15. The process as claimed in claim 1, in which the reaction mixture is heated by means of microwave radiation to temperatures above 110° C.

16. The process as claimed in claim 1, in which the reaction mixture comprises an acidic catalyst.

17. The process as claimed in claim 1, in which the reaction mixture comprises a strong electrolyte.

18. The process as claimed in claim 1, in which the microwave irradiation is effected in a flow tube made from microwave-transparent, high-melting material.

19. The process as claimed in claim 1, in which the longitudinal axis of the reaction tube in the direction of propagation of the microwaves is within a monomode microwave applicator.

20. The process as claimed in claim 1, in which the microwave applicator takes the form of a cavity resonator.
